(19) United States
(12) Patent Application Publication
(10) Pub. No.: US 2011/0008532 A1
(43) Pub. Date: Jan. 13, 2011

(54) METHOD OF MANUFACTURING HOT-RUNNER COMPONENT AND HOT-RUNNER COMPONENTS THEREOF

(75) Inventor: Murray Feick, Kitchener (CA)

Correspondence Address: MOLD-MASTERS (2007) Limited, 233 ARMSTRONG AVENUE, INTELLECTUAL PROPERTY DEPARTMENT, GEORGETOWN, ON, L7G-4X5, CA

(73) Assignee: MOLD-MASTERS (2007) LIMITED, Georgetown, ON (CA)

(21) Appl. No.: 12/809,599

(22) PCT Filed: Dec. 19, 2008
(86) PCT No.: PCT/CA08/02252

§ 371 Date: Sep. 21, 2010

Related U.S. Application Data
(60) Provisional application No. 61/016,274, filed on Dec. 21, 2007.

(51) Int. Cl. B29C 45/20; B29C 45/74; B29C 45/23; B22C 3/00

(52) U.S. Cl. 427/135; 425/547; 425/549; 425/564

(57) ABSTRACT

A method of manufacturing a hot-runner component includes providing a laser assembly, manufacturing a hot-runner component portion of a metallic material, introducing a property enhancing material to the hot-runner component portion, melting the property enhancing material onto the hot-runner component portion using a laser beam emitted from the laser assembly, and solidifying the melted property enhancing material on the hot-runner component portion.

### FIELD OF THE INVENTION

The present invention relates to injection molding, and more particularly, to hot runner components.

### BACKGROUND OF THE INVENTION

Hot-runner components are used in injection molding to deliver molding material (e.g., plastic melt, molten metal, etc) from a molding machine to a mold cavity or cavities. As such, hot-runner components are often susceptible to attack, such as wear, corrosion, and erosion by the molding material; wear from mechanical contact with neighboring components; and temperature cycling and fatigue from operating conditions. These and other problems can reduce the life of hot-runner components as well as reduce the quality of molded products.

### SUMMARY OF THE INVENTION

According to one aspect of the present invention, there is provided a hot-runner component includes a body made of a metallic material and a property enhancing material deposited on the body and metallurgically bonded to the body. The property enhancing material includes solidified laser clad material.

According to an example embodiment, there is provided A method of manufacturing a hot-runner component that comprises: providing a laser assembly; providing a hot-runner component portion of a metallic material; introducing a property enhancing material to the hot-runner component portion; melting the property enhancing material onto the hot-runner component portion using a laser beam emitted from the laser assembly; and solidifying the melted property enhancing material on the hot-runner component portion.

According to another example embodiment there is provided a hot-runner nozzle tip, comprising: a body having an upstream end and a downstream end, the body made of a thermally conductive material; a channel connecting the upstream end and the downstream end; a property enhancing material deposited on a part of the body and metallurgically bonded to the part of the body, the property enhancing material comprising solidified laser clad material.

According to another example embodiment there is provided A hot-runner valve pin, comprising: a cylindrical body made of a metallic material and having an upstream section for sealing with a valve pin bushing and a downstream section for contacting a mold gate; and a property enhancing material deposited on a surface of the cylindrical body and metallurgically bonded to the surface of the cylindrical body, the property enhancing material comprising solidified laser clad material.

### BRIEF DESCRIPTION OF THE FIGURES

Embodiments of the present invention will now be described more fully with reference to the accompanying drawings in which:

FIG. 1 is a schematic diagram of a hot-runner component manufacturing system according to an embodiment of the present invention;

FIG. 2 is a schematic diagram of position and movement of a nozzle tip during manufacture according to an embodiment of the present invention;

FIGS. 3a-b are schematic diagrams of nozzle tips according to embodiments of the present invention;

FIGS. 4a-b are schematic diagrams of nozzle tips according to embodiments of the present invention;

FIGS. 5a-b are schematic diagrams of a valve pin according to embodiments of the present invention;

FIG. 6 is a schematic diagram of a valve pin bushing according to an embodiment of the present invention;

FIG. 7 is a schematic diagram of a manifold according to an embodiment of the present invention; and

FIG. 8 is a schematic diagram of a nozzle according to an embodiment of the present invention.

### DETAILED DESCRIPTION OF THE INVENTION

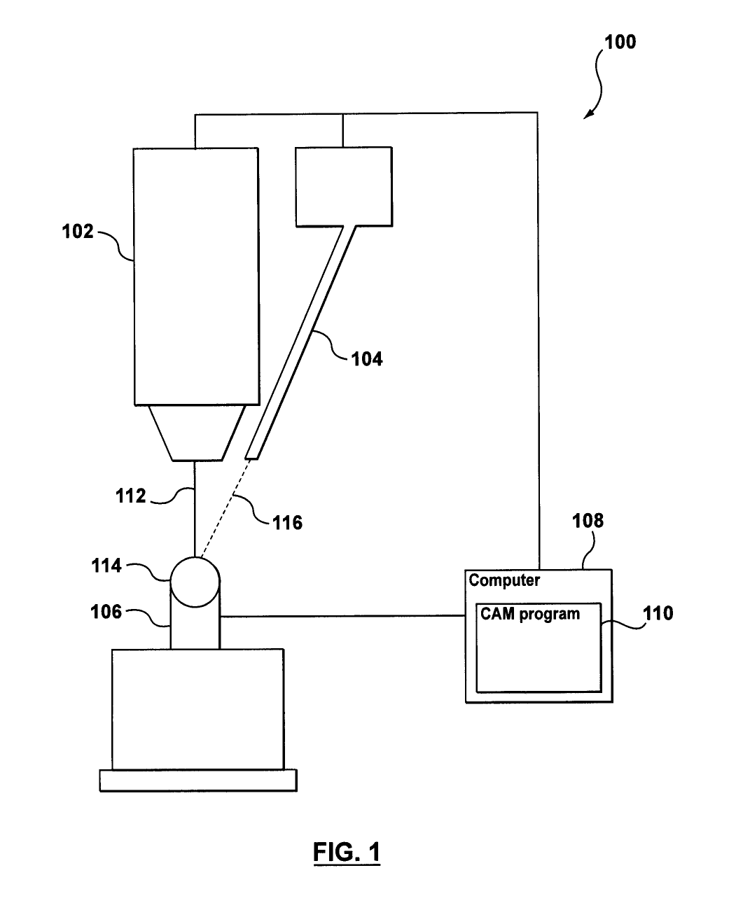

FIG. 1 shows a hot-runner component manufacturing system 100 according to an example embodiment of the present invention.

The hot-runner component manufacturing system 100 includes a laser assembly 102, a material feeder 104, an actuated holder 106, and a computer 108 loaded with an executable program 110. The hot-runner component manufacturing system 100 can process a hot-runner component portion 114.

The laser assembly 102 emits a laser beam 112. The laser beam 112 is any high-energy laser beam capable of fusing a property enhancing material to base material via what is known as laser cladding or laser welding. See U.S. Pat. No. 6,089,683, which is included herein by reference. As one skilled in the art will appreciate, the property enhancing material to be deposited may be introduced by pre-placing a particulate in the laser beam path or by injecting a stream of powder into the laser beam 112 and/or into the melt pool. The laser assembly 102 is controlled by parameters such as the power density of the laser beam 112, laser optics, laser scan frequency, and amplitude of the scan frequency to achieve suitable metallurgical bonding of the property enhancing material and the base material of the hot-runner component, as well as achieve suitable thickness of the deposited property enhancing material.

The material feeder 104 provides the property enhancing material. In this embodiment, the property enhancing material is introduced as a stream of powder 116 in the vicinity of where the laser beam 112 meets the hot-runner component portion 114, such that the property enhancing material melts on the hot-runner component portion 114. The laser beam 112 metallurgically bonds a property enhancing material to a base material of the hot-runner component portion 114 to form a hot-runner component. (The term “portion” denotes an incomplete component.)

A property enhancing material is defined as any material having properties desirable for a part of a hot runner component, but not suitable for the entire component due to machinability, availability, or another reason. The base material of the hot-runner component has properties desirable for some other part of the hot runner component. Generally, the base material is selected as the larger part of the hot runner component and the property enhancing material is a smaller part or a layer. For any given hot-runner component, more than one base material and more than one property enhancing material can be used.

An example of property enhancing material is a wear resistant material, such as nickel, chromium, carbides, tungsten, and alloys of these materials, among others.

Another example of property enhancing material is a lubricating material, such as certain copper alloys (e.g., bronze and brass), for example.

Base materials for hot-runner components can be metallic materials, such as steel, copper alloys (e.g., beryllium copper), titanium-zirconium-molybdenum alloy (TZM), among others. These materials can be thermally conductive or thermally insulative, depending on the hot-runner component's location and purpose in the hot runner.

The actuated holder 106 holds the hot-runner component portion 114 and can move the hot-runner component portion 114 relative to the laser beam 112. The actuated holder 106 can be a turning center, a lathe, a robot, conveyor, or similar apparatus that can rotate and/or translate the hot-runner component portion 114 relative to the laser assembly 102. In another embodiment, in which the laser assembly 102 is moved, a stationary holder can be used instead.

The computer 108 can be a personal computer, a specialized control unit, an onboard computer of a turning center, or similar device. The computer 108 runs the executable program 110, which can comprise a computer-aided manufacturing (CAM) program. In this embodiment, the program 110 controls the position and/or movement of the hot-runner component portion 114 relative to the laser beam 112, controls the parameters of the laser assembly 102, and controls introduction of the property enhancing material from the material feeder 104 (e.g., rate of flow of the powder stream 116).

The hot-runner component manufacturing system 100 can be used in a method of manufacturing a hot-runner component such as a nozzle tip, a valve pin, a valve pin bushing, a manifold, or a nozzle.

A method of manufacturing a hot-runner component according to an embodiment of the present invention includes manufacturing a hot-runner component portion 114, introducing a property enhancing material to the hot-runner component portion, melting the property enhancing material onto the hot-runner component portion 114 using a laser beam 112, and solidifying the melted property enhancing material on the hot-runner component portion 114.

Manufacturing the hot-runner component portion 114 can be done in the conventional manner, such as by machining, casting, turning, forming, or otherwise making the hot-runner component portion 114 from a metallic material.

Introducing a property enhancing material to the hot-runner component portion 114 can be done as described above. A particulate or powdered material can be introduced as stream 116, for example.

Melting the property enhancing material onto the hot-runner component portion 114 is achieved by a suitably powerful laser, such as the beam 112 provided by the laser assembly 102. The laser beam 112 heats the property enhancing material and/or the base material of the hot-runner component portion 114 to melt the property enhancing material.

Solidifying the melted property enhancing material on the hot-runner component portion 114 can be performed by moving the hot-runner component portion 114 relative to the laser beam 112, so that the melted material experiences less heat input. This can be done by translating and/or rotating the hot-runner component portion 114 by using, for example, the actuated holder 106. When the melted property enhancing material is moved away from the area heated by the laser beam 112, the property enhancing material cools and thus solidifies.

In this embodiment, the solidified property enhancing material is deposited at a thickness equal to or greater than 0.1 mm. Moreover, the method above can deposit even thicker layers of property enhancing material, such 0.5 mm or greater, should such thickness be required. Depending on the thickness of property enhancing material required, more than one pass may have to be made.

If net dimensions or tolerances cannot be achieved with the laser beam 112, the method can further include grinding the solidified property enhancing material to a rheological finish or to a sealing finish. A rheological finish can be provided to a hot-runner component that contacts flowing molding material, so as to achieve suitable molding material flow conditions. A sealing finish can be provided to a hot-runner component that forms a seal with another hot-runner component against leakage of molding material, gasses, etc.

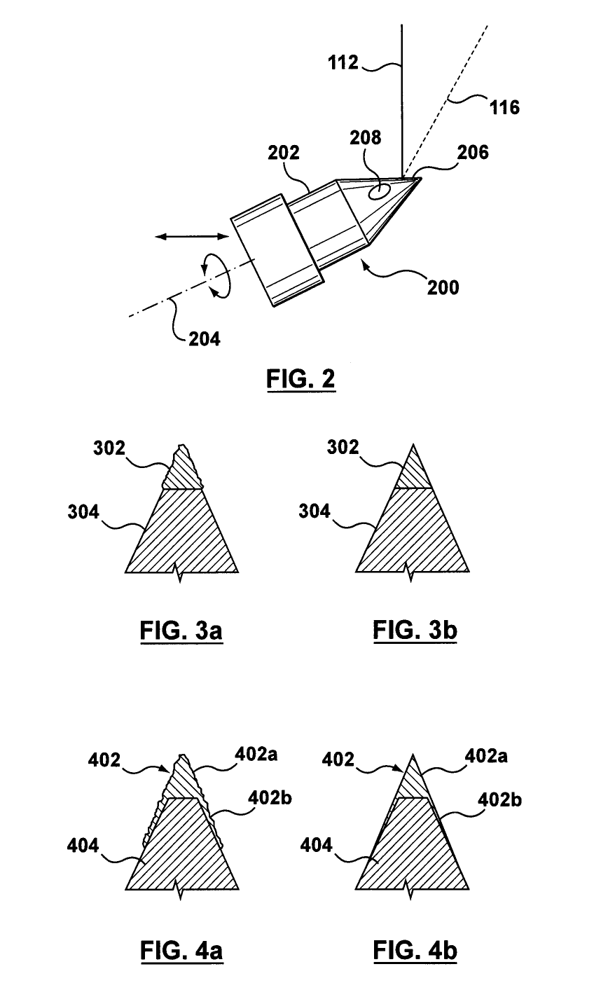

FIG. 2 shows a close-up of a nozzle tip 200 being made by the method and manufacturing system 100 described above, with particular attention being paid to position and movement of the nozzle tip 200.

The nozzle tip 200 includes a body 202 that is translated and/or rotated about a central axis 204. In this embodiment, the body 202 is translated along a path approximately perpendicular to the laser beam 112 and rotated about the central axis 204, such that the laser beam 112 contacts a surface 206 that is generally perpendicular to the laser beam 112. At this surface 206, property enhancing material is provided via the stream 116. The perpendicularity of the surface 206 reduces the amount of melted property enhancing material that may drip from the body 202 or improperly solidify on the body 202 because of gravity.

In this embodiment, the body 202 has an upstream end (near 204) and a downstream end (near 206) and is made of a thermally conductive material (e.g., beryllium copper). A channel 208 connects the upstream end and the downstream end for flow of molding material. The property enhancing material is deposited on a part of the body (near 206) and metallurgically bonded to the part of the body 202.

For hot-runner components of other shapes or deposited property enhancing material having other shapes, different modes of rotation and/or translation can be used.

FIGS. 3a-b and 4a-b are schematic diagrams of nozzle tips according to embodiments of the present invention. The nozzle tips can be manufactured using the hot-runner component manufacturing system 100 and methods described herein. Only the downstream ends of the nozzle tips are shown for clarity.

In FIGS. 3a-b, a tip 302 is a conical piece of built-up property enhancing material deposited on a downstream part of the body (nozzle tip portion) 304 of a nozzle tip. FIG. 3a shows the conical tip 302 as deposited by a laser. FIG. 3b shows the conical tip 302 as ground to a rheological finish. If a rheological finish can be achieved with the laser alone, then FIG. 3a does not apply.

In FIGS. 4a-b, a tip 402 has a conical piece 402a of built-up property enhancing material and an adjacent layer 402b of property enhancing material deposited on a downstream part of the body (nozzle tip portion) 404 of a nozzle tip. FIG. 4a shows the conical tip 402a and layer 402b as deposited by a laser. FIG. 4b shows the conical tip 402a and layer 402b as ground to a rheological finish. If a rheological finish can be achieved with the laser alone, then FIG. 4a does not apply.

Regarding the above-described method, the structure of FIGS. 3a-b can be achieved by introducing property enhancing material to the downstream end of the nozzle tip portion (body) 304, 404, building up a conical tip (piece) 302, 402 of property enhancing material on the nozzle tip portion 304, 404, and, if necessary, grinding the solidified property enhancing material to a rheological finish. The structure of FIGS. 4a-b further requires depositing a layer 402a, 402b of the property enhancing material adjacent the built-up conical tip 302, 402.

If the nozzle tips are expected to undergo wear from the flow of molding material (e.g., resin having abrasive filler), the property enhancing material can include a wear resistant material. If flow conditions of molding material are to be improved, the property enhancing material can include a lubricating material. The same or other features can be realized by selecting the appropriate property enhancing material.

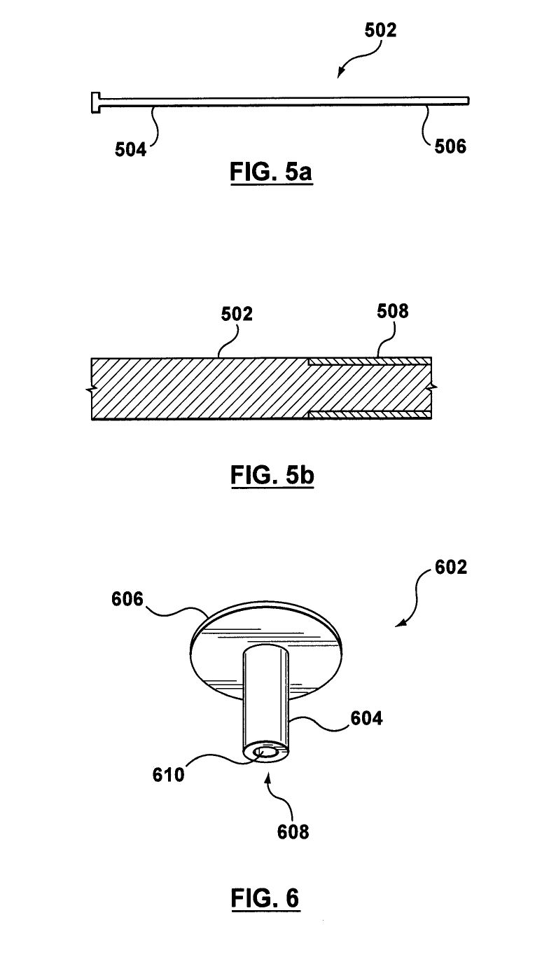

FIGS. 5a-b show schematic diagrams of a valve pin 502 according to an embodiment of the present invention. The valve pin 502 can be manufactured using the hot-runner component manufacturing system 100 and methods described herein.

The valve pin 502 is a cylindrical body made of a metallic material and has an upstream section 504 and a downstream section 506. When in operation in a hot runner, the upstream section 504 may need to seal with a valve pin bushing and the downstream section 506 may be exposed to flowing molding material and may repeatedly contact or strike a mold gate. As such, wear resistant and/or lubricating property enhancing materials can be deposited on the valve pin 502 and can be given rheological and/or sealing finishes. FIG. 5b shows an example of property enhancing material layer 508 deposited on a surface of the cylindrical body of the valve pin 502.

FIG. 6 shows a schematic diagram of a valve pin bushing 602 according to an embodiment of the present invention. The valve pin bushing 602 can be manufactured using the hot-runner component manufacturing system 100 and methods described herein.

The valve pin bushing 602 has a body (valve pin bushing portion) 604 made of a metallic material attached to a disc portion 606. A valve pin bore 608 extends through the body 604. A property enhancing material is deposited on a surface 610 of the valve pin bore, against which a valve pin slides.

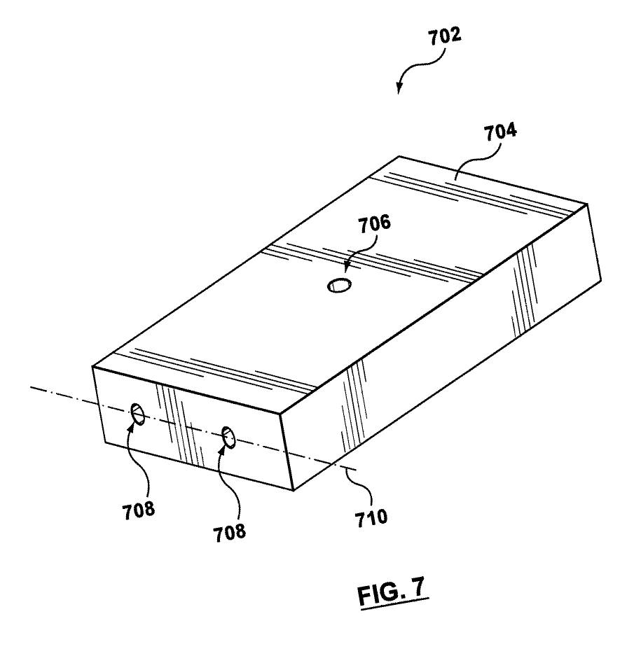

FIG. 7 shows a schematic diagram of a manifold 702 according to an embodiment of the present invention. The manifold 702 can be manufactured using the hot-runner component manufacturing system 100 and methods described herein.

The manifold 702 has a manifold body (manifold portion) 704, such as a plate, made of a metallic material. The manifold 702 has an inlet channel 706, outlet channels (not shown), and runner channels 708 extending in the manifold body 704. Some of these channels are blocked or redirected by manifold plugs before installation into a hot runner. A property enhancing material is deposited on interior surfaces of one or more of the channels. To facilitate this, the manifold body 704 can be manufactured in two pieces defined by a split line 710 aligned with one or more of the channels. Thus, each piece of the manifold body 704 can be treated as a hot-runner component portion for the purpose of metallurgically bonding the property enhancing material thereon using a laser, with the exposed channel halves facilitating simple access for the laser beam. The pieces of the manifold body 704 can be joined by brazing or a similar bonding method.

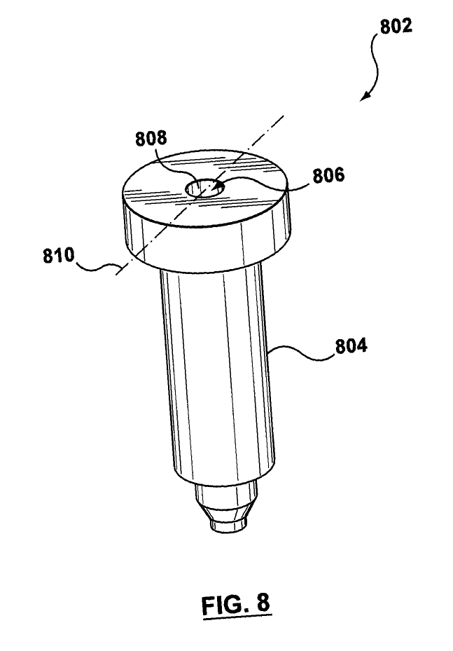

FIG. 8 shows a schematic diagram of a nozzle 802 according to an embodiment of the present invention. The nozzle 802 can be manufactured using the hot-runner component manufacturing system 100 and methods described herein.

The nozzle 802 includes a nozzle body (nozzle portion) 804 made of a metallic material. A channel 806 extends through the nozzle body 804. A property enhancing material is deposited on an interior surface 808 of the channel 806. To facilitate this, the nozzle body 804 can be manufactured in two pieces defined by a split line 810 aligned with the channel 806. Thus, each piece of the nozzle body 804 can be treated as a hot-runner component portion for the purpose of metallurgically bonding the property enhancing material thereon with a laser, with the exposed channel halves facilitating simple access for the laser beam. The pieces of the nozzle body 804 can be joined by brazing or a similar bonding method.

Regarding depositing property enhancing material within enclosed channels of hot-runner components, such as manifolds, nozzles, and nozzle tips, the method and/or apparatus of U.S. Pat. No. 6,486,432, which is included herein by reference, can be adapted if splitting the component is to be avoided.

Methods of manufacturing hot-runner components as described herein also encompass refurbishing worn hot-runner components.

A hot-runner component to be refurbished may have worn down portions of property enhancing material. For example, the sharp built-up conical tips 302, 402 of FIGS. 3b, 4b may become rounded after extended contact with flowing molding material during injection cycles. In another example, the layer 508 deposited on a surface of the cylindrical body of the valve pin 502 of FIG. 5 may have thinned portions resulting from wear with contacting surfaces.

As such, manufacturing methods described herein can be used to apply property enhancing material directly onto the worn component without prior treatment beyond cleaning. Alternatively, it may be desirable to remove previously deposited property enhancing material from the hot-runner component portion, before introducing new property enhancing material.

Although many embodiments of the present invention have been described, those of skill in the art will appreciate that other variations and modifications may be made without departing from the spirit and scope thereof as defined by the appended claims. All patents and publications discussed herein are incorporated in their entirety by reference thereto.

What is claimed is:

1. A method of manufacturing a hot-runner component, comprising:
providing a laser assembly;
providing a hot-runner component portion of a metallic material;
introducing a property enhancing material to the hot-runner component portion;
melting the property enhancing material onto the hot-runner component portion using a laser beam emitted from the laser assembly; and
solidifying the melted property enhancing material on the hot-runner component portion.

2. The method of claim 1 further comprising grinding the solidified property enhancing material to a rheological finish.

3. The method of claim 1 further comprising grinding the solidified property enhancing material to a sealing finish.

4. The method of claim 1, wherein the solidified property enhancing material has a thickness equal to or greater than 0.1 mm.

5. The method of claim 4, wherein the solidified property enhancing material has a thickness equal to or greater than 0.5 mm.

6. The method of claim 1, wherein solidifying the melted property enhancing material is performed by moving the hot-runner component portion relative to the laser beam.

7. The method of claim 6, wherein the hot-runner component portion is rotated relative to the laser beam.

8. The method of claim 6, wherein the hot-runner component portion is translated relative to the laser beam.

9. The method of claim 1 further comprising providing an actuated holder for holding and moving the hot-runner component portion, and providing a computer and an executable program that control the laser assembly, control introduction of the property enhancing material, and control the position of the hot-runner component portion relative to the laser beam.

10. The method of claim 1, wherein the property enhancing material comprises a particulate.

11. The method of claim 1, wherein the property enhancing material is introduced as a stream of powder.

12. The method of claim 1, wherein the property enhancing material is a wear resistant material.

13. The method of claim 1, wherein the property enhancing material is a lubricating material.

14. The method of claim 1, wherein the hot-runner component portion is a nozzle tip portion.

15. The method of claim 14 further comprising building up a conical tip of property enhancing material on the nozzle tip portion.

16. The method of claim 15 further comprising depositing a layer of the property enhancing material adjacent the built-up conical tip of the nozzle tip portion.

17. The method of claim 1, wherein the hot-runner component portion is a valve pin portion.

18. The method of claim 1, wherein the hot-runner component portion is a valve pin bushing portion.

19. The method of claim 1, wherein the hot-runner component portion is a manifold portion.

20. The method of claim 1, wherein the hot-runner component portion is a nozzle portion.

21. The method of claim 1, wherein the property enhancing material comprises a material selected from the group consisting of nickel, chromium, carbides, tungsten, and copper.

22. The method of claim 1, wherein the hot-runner component portion is made from a material selected from the group consisting of steel, copper alloy, and titanium-zirconium-molybdenum alloy.

23. The method of claim 1, further comprising, before introducing the property enhancing material to the hot-runner component portion, cleaning the hot-runner component portion.

24. The method of claim 1, further comprising, before introducing the property enhancing material to the hot-runner component portion, removing previously solidified property enhancing material from the hot-runner component portion.

25. A hot-runner component, comprising:
a body made of a metallic material;
a property enhancing material deposited on the body and metallurgically bonded to the body, the property enhancing material comprising solidified laser clad material.

26. The hot-runner component of claim 25, wherein the property enhancing material has a thickness equal to or greater than 0.1 mm.

27. The hot-runner component of claim 26, wherein the property enhancing material has a thickness equal to or greater than 0.5 mm.

28. The hot-runner component of claim 25, wherein the property enhancing material is a wear resistant or lubricating material.

29. The hot-runner component of claim 25, further comprising built-up property enhancing material.

30. The hot-runner component of claim 25, wherein the body is a nozzle tip portion, a valve pin portion, a valve pin bushing portion, a manifold portion, or a nozzle portion.

31. A hot-runner nozzle tip, comprising:
a body having an upstream end and a downstream end, the body made of a thermally conductive material;
a channel connecting the upstream end and the downstream end;
a property enhancing material deposited on a part of the body and metallurgically bonded to the part of the body, the property enhancing material comprising solidified laser clad material.

32. The hot-runner nozzle tip of claim 30, wherein the property enhancing material has a thickness equal to or greater than 0.1 mm.

33. The hot-runner nozzle tip of claim 32, wherein the property enhancing material has a thickness equal to or greater than 0.5 mm.

34. The hot-runner nozzle tip of claim 31, wherein the property enhancing material is a wear resistant material.

35. The hot-runner nozzle tip of claim 31, wherein the property enhancing material is a lubricating material.

36. The hot-runner nozzle tip of claim 31, wherein the part of the body is the downstream end of the nozzle tip.

37. The hot-runner nozzle tip of claim 36, further comprising a conical tip of built-up property enhancing material.

38. The hot-runner nozzle tip of claim 37, further comprising a layer of property enhancing material deposited adjacent the built-up conical tip.

39. A hot-runner valve pin, comprising:
a cylindrical body made of a metallic material and having an upstream section for sealing with a valve pin bushing and a downstream section for contacting a mold gate; and
a property enhancing material deposited on a surface of the cylindrical body and metallurgically bonded to the surface of the cylindrical body, the property enhancing material comprising solidified laser clad material.

40. The hot-runner valve pin of claim 39, wherein the property enhancing material has a thickness equal to or greater than 0.1 mm.

41. The hot-runner valve pin of claim 40, wherein the property enhancing material has a thickness equal to or greater than 0.5 mm.

42. The hot-runner valve pin of claim 39, wherein the property enhancing material is a wear resistant material.

43. The hot-runner valve pin of claim 39, wherein the property enhancing material is a lubricating material.

44. The hot-runner valve pin of claim 39, wherein the property enhancing material is deposited on the upstream section or the downstream section.
